(19) United States
(12) Patent Application Publication
(10) Pub. No.: US 2023/0276743 A1
(43) Pub. Date: Sep. 7, 2023

(54) SEEDLING TRANSPORT APPARATUS

(71) Applicants: Jae Seung HUH, Hongcheon-gun (KR); Da Jung CHON, Hongcheon-gun (KR)

(72) Inventors: Jae Seung HUH, Hongcheon-gun (KR); Da Jung CHON, Hongcheon-gun (KR)

(21) Appl. No.: 18/020,036

(22) PCT Filed: Mar. 29, 2021
(86) PCT No.: PCT/KR2021/003881

§ 371 Date: Mar. 6, 2023

(30) Foreign Application Priority Data
Aug. 18, 2020 (KR) 10-2020-0103255

(51) Int. Cl. A01G 9/029; F16M 13/04

(52) U.S. Cl. CPC A01G 9/0299; F16M 13/04

(57) ABSTRACT

A seedling carrying device is provided, including a main body configured to support a seed tray, support parts connected to both sides of one side of the main body, a strap part including two terminals connected to the support parts and configured to be placed on a user's shoulder, and a reinforcing part connected to a center portion of the other side of the main body and connected to a center portion of the strap part.

### TECHNICAL FIELD

The present disclosure relates to a seedling carrying device, and more particularly, to a seedling carrying device configured to maintain a seed tray in a parallel state to the ground even if a user's body moves or the seedling carrying device is moved from one side of the user's body to the other side when the seedling carrying device with the seed tray seated therein is placed on the user's shoulder for use.

### BACKGROUND

Typically, crop (e.g., peppers, cucumbers, potatoes, melons, watermelons, eggplants, tomatoes, perilla, etc.) seedlings are sown in seed trays of a certain shape, germinated, and then transplanted to the ground. The growing period of crops is adjusted to the climate and crops are encouraged to grow faster than weeds by the seedling transplant so that a higher yield may be produced. Seedlings are sown and grown in seed trays filled with potting soil (e.g., seedling soil), and care must be taken not to damage the roots of the seedlings when separating from the seed trays and transplanting fully grown seedlings.

In transplanting seedlings, it is very important for the growth and health of the crop to transplant seedlings such that the potting soil mass attached to the roots of the seedling reaches the target planting space of the ground by the falling force from an appropriate height without breaking loose so that the potting soil spreads well into the ground soil.

In addition, since the size and cultivation technique of seedlings are all different for each crop, the optimal planting interval needs to be maintained while the optimal planting depth is maintained for each crop seedling to grow high-yielding and high-quality crops.

Since the user takes out each seedling from the seed tray and transplants the seeding by hand if the user performs seedling transplant work manually, a long working time is required and the seedlings are sometimes damaged by carelessness during the work. In addition, since the user takes out the seedlings for seedling transplant work while carrying the seed tray with him or placing the seed tray near a transplanting site, it is difficult to work alone.

Seedling transplant is performed by a team of at least two users. For example, a first user of the two users secures a space in the ground for transplant with a seedling transplanter, and then a second user puts the seedlings into the seedling transplanter. This work can be done by a single worker, but in this case, arranging the seed trays, taking out the seedlings from the seed trays, etc., need to be carried out by the single worker, which poses a problem of increased physical fatigue and decreased work efficiency.

### SUMMARY

An object of the present invention is to provide a seedling carrying device that maintains a seed tray in a parallel state to the ground even if a user's body moves or the seedling carrying device is moved from one side of the user's body to the other side when the seedling carrying device with the seed tray seated therein is placed on the user's shoulder for use, so that the worker may take out the seedlings and put the seedings into a seedling transplanter easily.

A seedling carrying device is provided, which may include a main body configured to support a seed tray, support parts connected to both sides of one side of the main body, a strap part including two terminals connected to the support parts and configured to be placed on a user's shoulder, and a reinforcing part connected to a center portion of the other side of the main body and connected to a center portion of the strap part.

The seedling carrying device may include a seating part mounted on one surface of the body and on which a lower surface of the seed tray is seated.

The strap part may be configured such that, if the main body is positioned on one side of a user's waist, the strap part may be placed on a shoulder in a same direction as the other side of the user's waist.

The reinforcing part may include a reinforcing bar configured to protrude at a predetermined angle with respect to one side of the main body, and a sub-strap including two terminals connected to one terminal of the reinforcing bar and to the center portion of the strap part.

The reinforcing bar may include a coupling hole formed at an upper end, and one terminal of the sub-strap may be connected to the coupling hole, and the other terminal is connected to the strap part.

When the strap part is placed on the user's shoulder, the sub-strap may be connected to the center portion of the strap part to form a triangular pyramid having the shoulder as an apex.

The reinforcing part may be configured such that, if the user wearing the strap part placed on the user's shoulder turns waist in one direction, the user's shoulder may turn in one direction about the apex at which the strap part is placed as an axis and the sub-strap may be pulled in the axial direction, so that the sub-strap may restrict tilt of the main body in the direction in which the waist is turning relative to a longitudinal direction of the reinforcing bar, thereby maintaining the main body in a horizontal state with respect to the ground.

The reinforcing part may be configured such that, if the user wearing the strap part on the user's shoulder moves the main body to a front or rear with respect to the user's body, the sub-strap may be pulled toward the apex where the strap part is placed, so that the sub-strap may restrict tilt of the main body in the direction in which the main body is moving relative to the longitudinal direction of the reinforcing bar, thereby maintaining the main body horizontally with respect to the ground.

the main body may be configured to adjust a size of the main body in a longitudinal direction of the main body.

The main body may include: a fixed body including a frame including first fastening holes formed on both sides; and a movable body to be inserted into the frame of the fixed body and including second fastening holes corresponding to the first fastening holes.

The main body may be configured to adjust the size of the main body in a depth direction of the main body.

The main body main include at least one insertion recess formed in an inner surface of the frame of the main body, and a seating part on which a lower surface of the seed tray is seated, and which includes a seating part shaft to be inserted into and fastened to the insertion recess.

The seedling carrying device may further include a cushion part formed on a portion of one side of the main body and configured to be in contact with the user's waist.

According to some examples of the present disclosure, even if the user turns waist in one direction while having the main body with the seed tray seated therein of the seedling carrying device placed at the user's waist, the strap part placed on the shoulder and the sub-strap connected to the strap part maintain the main body in a parallel state to the ground such that it is possible to easily take out the seedlings and put them into the seedling transplanter.

According to some examples of the present disclosure, the seedling carrying device is designed such that the lowest surface of the main body is positioned above the user's waist to prevent bumping into the user's leg so that the user of the seedling carrying device may move freely. In addition, as the user walks comfortably according to the configuration of such a seedling carrying device, the seedlings can be protected during the seedling transplant work and the user's fatigue can be reduced in transplanting the seedlings at regular intervals between furrows.

According to some examples of the present disclosure, the reinforcing bar forming the reinforcing part in the seedling carrying device prevents the seed tray from separating from the main body so that the user may work intently.

According to some examples of the present disclosure, the sub-strap forming the reinforcing part of the seedling carrying device is connected to the center portion of the strap part placed on the user's shoulder and is positioned across from the strap part to form a triangular pyramid with the shoulder serving as the apex such that the main body is stably positioned at the waist so that the user may easily take out the seedlings from the seed tray.

According to some examples of the present disclosure, if the user wearing the seedling carrying device turns waist in one direction, the sub-strap is turned at an acute angle in one direction about the apex of the user's shoulder on which the strap part is placed, so that the main body may remain horizontal with respect to the ground surface. In addition, even if the position of the main body is moved to the front or rear with respect to the user's body, the main body may stably remain horizontal with respect to the ground.

The effects of the present disclosure are not limited to the effects described above, and other effects that are not mentioned above can be clearly understood to those skilled in the art based on the description provided below.

### BRIEF DESCRIPTION OF THE DRAWINGS

Embodiments of the present disclosure will be described with reference to the accompanying drawings described below, where similar reference numerals indicate similar elements but not limited thereto, in which:

FIG. 1 is a perspective view of a seedling carrying device;

FIG. 2 is an exploded perspective view of a seedling carrying device;

FIG. 3 is a front view of a seedling carrying device;

FIG. 4 is a perspective view of a seedling carrying device;

FIG. 5 is an exploded perspective view of a seedling carrying device;

FIG. 6 is a front view showing an example of use of a seedling carrying device;

FIG. 7 is an exemplary view showing a state in which a seedling carrying device is placed on a user's shoulder;

FIG. 8 is an exemplary view showing a state in which a main body of a seedling carrying device is rotated to the front or back of a user while being placed on the user's shoulder;

FIG. 9 is an exemplary diagram illustrating a state in which a user performs a seedling transplant work while the seedling carrying device is placed on the user's shoulder;

FIG. 10 is a perspective view showing an example of a configuration for variably adjusting the size of a main body used in a seedling carrying device in a horizontal direction;

FIG. 11 is a front view showing an example of a configuration in which the size of a seating part is variably adjusted in a vertical direction in a seedling carrying device; and

FIG. 12 is a front view showing another example of a configuration in which the size of the seating part is variably adjusted in the vertical direction in the seedling carrying device.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of the embodiments, duplicate descriptions of the same or corresponding elements may be omitted. However, even if descriptions of elements are omitted, it is not intended that such elements are not included in any example.

Advantages and features of the disclosed examples and methods of accomplishing the same will be apparent by referring to examples described below in connection with the accompanying drawings. However, the present disclosure is not limited to the embodiments disclosed below, and may be implemented in various different forms, and the embodiments are merely provided to make the present disclosure complete, and to fully disclose the scope of the invention to those skilled in the art to which the present disclosure pertains.

The terms used in the present disclosure will be briefly described prior to describing the disclosed embodiment(s) in detail.

The terms used herein have been selected as general terms which are widely used at present in consideration of the functions of the present disclosure, and this may be altered according to the intent of an operator skilled in the art, conventional practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms.

Further, throughout the description, when a portion is stated as “comprising (including)” an element, it intends to mean that the portion may additionally comprise (or include or have) another element, rather than excluding the same, unless specified to the contrary.

As used herein, the statement “A and/or B” means A, or B, or A and B.

Hereinafter, preferred embodiments of the present disclosure will be described in detail with reference to the accompanying drawings so that those with ordinary knowledge in the art can easily achieve the present disclosure. However, in describing an operating principle of the preferred embodiment of the present invention in detail, a detailed description of known functions and configurations incorporated herein will be omitted when it may unnecessarily make the subject matter of the present invention rather unclear.

In addition, same reference numerals are used for parts having similar functions and operations throughout the drawings.

In addition throughout the description, when a portion is stated as being “connected” to another portion, it intends to include not only an example where the portions are “directly connected” but also an example where the portions are indirectly connected while being another components therebetween. Further, throughout the description, when an element is stated as “comprising (including)” a certain element, unless specified to the contrary, it intends to mean that the element may additionally include another element, rather than foreclosing the same.

Hereinafter, a seedling carrying device according to certain examples will be described in detail with reference to the accompanying drawings.

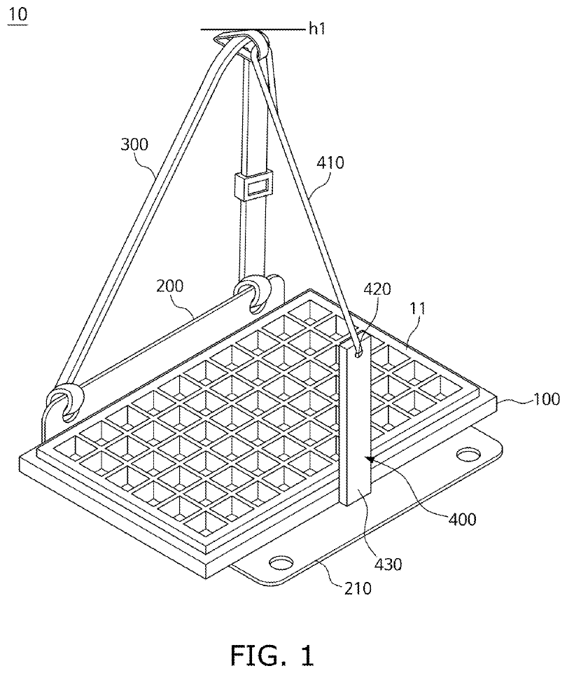

FIG. 1 is a perspective view of a seedling carrying device 10. As shown, the seedling carrying device 10 may include a main body 100, a support part 200, a strap part 300, and a reinforcing part 400. The main body 100 substantially corresponds in size to a seed tray 11 and may be formed in the shape of a square frame. In addition, the seedling carrying device 10 may include a seating part 210 that is mounted on one side of the main body 100, so that a lower surface of the seed tray 11 is seated thereon. Alternatively, the seedling carrying device 10 may not include the seating part 210, in which case the seedling carrying device 10 may be configured such that the seed trays 11 of different depths may be mounted through the center portion of the square frame of the main body 100. The main body 100 is shown as a rectangular frame in FIG. 1 but is not limited thereto and may be configure in various forms including a polygon or a circle.

The support part 200 may be configured so as to be connected to the seating part 210 on which the seed tray 11 is seated and support the frame of the main body 100. The support part 200 may include two holes formed on both sides of a lower end and/or one side connected to the bottom of the main body 100. The strap part 300 includes two terminals connected to the support part 200, in which one end of the strap part 300 is connected to a hole formed on one side of the support part 200, and the other terminal is connected to the other hole formed on the other side of the support part 200. If the seedling carrying device with this configuration is used, when the main body 100 and/or the support part 200 are positioned on one side of the user's waist, the strap part 300 may be placed on the shoulder on the same side as the other side of the user's waist. The strap part 300 may include a length adjuster for adjusting the length according to the user's physical features.

The reinforcing part 400 may be formed in the center portion of the other side of the main body 100. The reinforcing part 400 may include a reinforcing bar 430 formed substantially perpendicular to the plane of the main body 100, a coupling hole 420 formed at an upper end of the reinforcing bar 430, and a sub-strap 410 having one terminal connected to the coupling hole 420 and the other terminal connected to the strap part 300. The sub-strap 410 may include a length adjuster having a predetermined width and thickness for adjusting the length so that the main body 100 and/or the support part 200 remain horizontal with respect to the ground according to the user's physical features. According to the configuration described above, the main body 100 remains horizontal with respect to the ground so that the seed tray 11 is prevented from separating or falling from the main body 100 while the user moves his body or works on seedlings.

The reinforcing bar 430 is configured in the shape of a substantially rectangular or elongated plate having predetermined length and thickness, but are not limited thereto, and may be formed in various shapes such as a gently curved shape, a curved rod shape, etc. The reinforcing bar 430 may be configured to have a length substantially equal to or greater than the length of the seedling. With the reinforcing bar 430 configured as described above, it is possible to prevent damage to the seedling or seedling leaf caused by a collision between the moving seedling and the sub-strap 410 or the reinforcing bar during seedling transplant work by the user. For example, if the length of the reinforcing bar 430 is approximately 20 cm or more, and if lettuce or Chinese cabbage whose seedling is generally at least 3 cm high or pepper, overgrown corn, red bean, or perilla whose seedling grows up to 20 cm or more is accommodated in the seed tray 11 and seated in the seating part 210, it is possible to prevent the sub-strap 410 coming down from the shoulder from rubbing against and damaging the seedling leaves during work.

If the user positions the main body 100 and/or the support part 200 on one side of the waist, the strap part 300 may be placed on a shoulder positioned on the same side as the other side of the user's waist. If the sub-strap 410 is connected to substantially the center portion of the strap part 300 and the connecting point is at an apex h1 on the user's shoulder, the strap part 300 and the sub-strap 410 may form a substantially triangular pyramid shape. According to this configuration, both ends of the strap part 300 placed on one shoulder of the user may pull and support both ends of one side of the main body 100, and the sub-strap 410 connected to the center portion of the strap part 300 serves to pull one end of the reinforcing bar 430 toward the user's body. At the same time, the other end of the reinforcing bar 430 may be fixed to the center portion of the other end of the main body 100 so that the main body 100 is prevented from tilting toward the ground. Therefore, even if the user moves the seedling carrying device 10 to the front, back, or side of the user's body as needed during seedling carrying or transplant work, the main body 100 may remain horizontal with respect to the ground by the structure of the strap part 300, the sub-strap 410, and the reinforcing bar 430 connected to the main body 100.

If the user wearing the seedling carrying device 10 turns his waist in one direction (for example, if the user bends at the waist toward the ground for transplanting seedlings), the user's shoulder turns in one direction about the apex h1 at which the strap part 300 is placed as an axis, thereby pulling the sub-strap 410 connected to the strap part 300. The sub-strap 410 may maintain the main body 100 in a horizontal state with respect to the ground by restricting a tilt of the vertical axis (for example, the longitudinal direction of the reinforcing bar 430) in the turning direction of the waist.

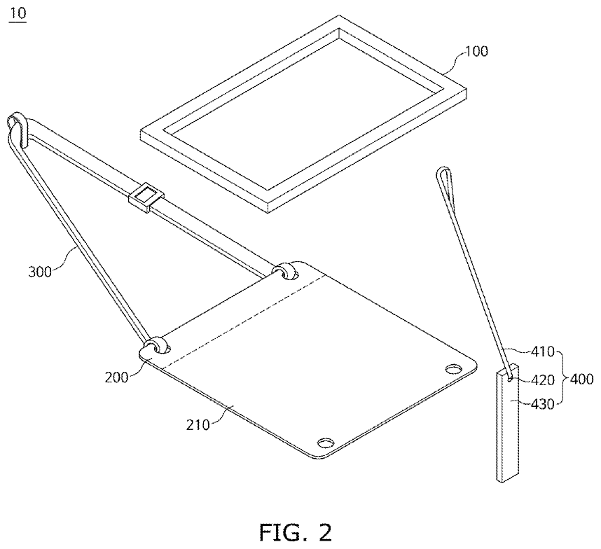

FIG. 2 is an exploded perspective view of the seedling carrying device 10. The seedling carrying device 10 may include the main body 100, the support part 200, the strap part 300, and the reinforcing part 400. As shown, the reinforcing part 400 may include the sub-strap 410, the coupling hole 420, and the reinforcing bar 430.

The support part 200 may be attached to a lower end of the main body 100 while being connected to the seating part 210. Alternatively, the support part 200 may be attached to one side of the main body 100 while the seating part 210 is in the state of being attached to the lower end of the main body 100. If the support part 200 is provided on one side of the main body 100, the reinforcing bar 430 may be provided at the center portion of the other side of the main body 100. If the support part 200 is provided on the lower end of the main body 100, the reinforcing bar 430 may be connected to one side of the seating part 210 that is in contact with the lower end of the main body 100. The seating part 210 may be formed wider than an edge of the main body 100 and formed of a flexible material such as waterproof fabric, silicon, rayon, or nylon. The seating part 210 made of such a material may prevent soil or water from falling to the ground when the user takes out the seedlings accommodated in the seed tray 11. The support part 200 may be formed of a flexible material such as waterproof fabric, silicone, rayon, or nylon. A ring member may be coupled to the connecting hole connected to the strap part 300 in the support part 200 so that, when the seedling carrying device is used while the strap part 300 is in the state of being connected to the connecting hole of the support part 200, stretching and tearing of the support part 200 and the seating part 210 caused by the weight of the main body 100 or the seed tray seated in the support part 200 may be prevented. The configurations or arrangement positions of the support part 200 and the reinforcing bar 430 are not limited to the configurations described above, and the configurations or arrangements may change as long as the support part 200 can be maintained in the horizontal state with respect to the ground when the seedling carrying device is used. In addition, the material of the seating part 210 is not limited to the materials described above and the seating part 210 may be made of a material having certain rigidity such as wood or metal.

The main body 100 may have a shape substantially corresponding to the shape of the seed tray. For example, the main body 100 may be formed as a square frame having an inner space or hole smaller than at least the edge of the seed tray to receive the lower protruding portion of the seed tray to be seated therein. Since the main body 100 positioned on one side of the user's waist may apply pressure to a corresponding part of the user's body, the main body 100 may be made of a light material. In addition, attaching a cushion pad to the outer surface of the main body 100 that comes in contact with the waist may prevent an injury caused by the outer surface of the main body 100 pressing or rubbing against the wearer's waist when the user works wearing the seedling carrying device 10. While the main body 100 is illustrated and described herein as the square frame, aspects are not limited thereto, and it may have other shapes such as a circular shape or a polygonal shape.

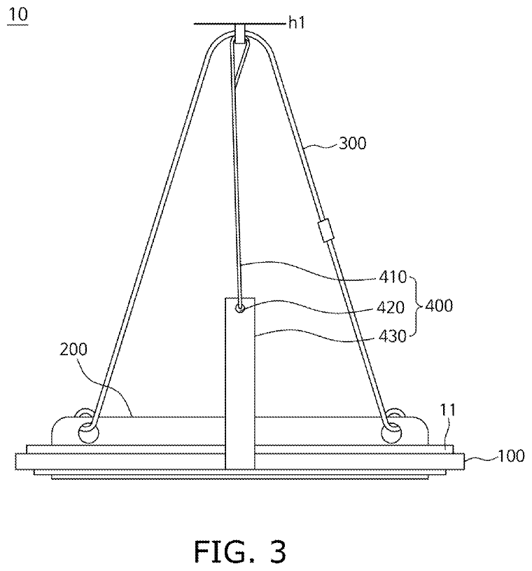

FIG. 3 is a front view showing an example of using the seedling carrying device 10. FIG. 3 may be a front view of the seedling carrying device 10, showing a state in which the user is wearing the seedling carrying device 10, in which the main body 100 is in contact with one side of the user's waist and the strap part 300 and the sub-strap 410 are pulled from the one side of the wearer's waist toward the shoulder on the same side as the other side of the user's waist. As shown, the two terminals of the strap part 300 may be connected to both sides of the support part 200. The support part 200 may be provided on one side of the main body 100, and the reinforcing bar 430 may be provided on the other side. The sub-strap 410 may be connected to the coupling hole 420 formed at an upper end of the reinforcing bar 430. One terminal of the sub-strap 410 may be connected to the apex h1 in the center portion of the strap part 300 that is in contact with the user's shoulder, and the other terminal may be connected to the coupling hole 420 formed at the upper end of the reinforcing bar 430. The upper end of the main body 100 may be configured to have a shape substantially corresponding to the size of the seed tray, and the lower end may be configured to be smaller than or equal to the size of the seed tray.

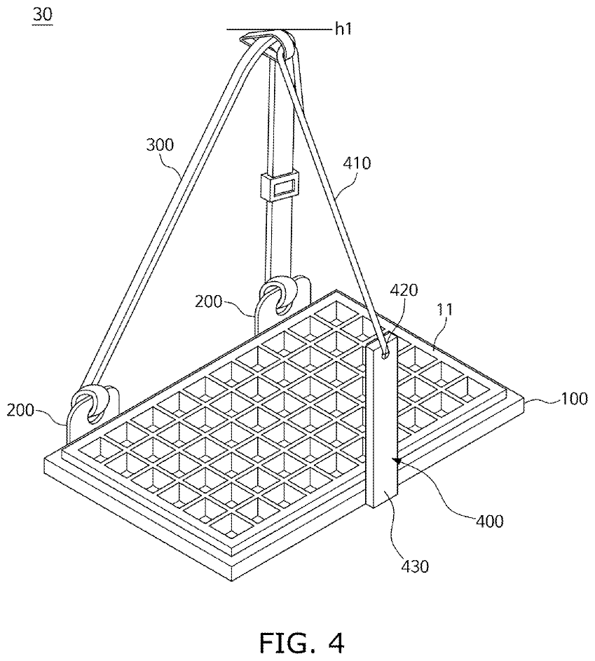

FIG. 4 is a perspective view of a seedling carrying device 30. As shown, the seedling carrying device 30 may include the main body 100, the support part 200, the strap part 300, and the reinforcing part 400. Compared to the seedling carrying device 10 shown in FIGS. 1 to 3, the seedling carrying device 30 may not include the seating part 210 connected to the support part 200 and mounted on one side of the main body 100. In addition, in the seedling carrying device 30, the support part 200 may be formed on both sides of one side of the main body 100. In describing the configuration of the seedling carrying device 30 below, the same reference numerals may be used for referring to components having the same or similar configurations or functions as those of the seedling carrying device 10 shown in FIGS. 1 to 3, and a detailed description thereof may be omitted.

The main body 100 may be configured as a substantially rectangular frame with an open center portion. The seed tray 11 may be inserted into and mounted in the frame of the main body 100, and if the seating part is not provided in the center portion of the frame, it is possible to mount the seed tray 11 having various depths. The support part 200 may be mounted on both sides of one side of the frame of the main body 100 or may be mounted on both sides of the lower end of the frame of the main body 100. The reinforcing bar 430 may be provided substantially at the center portion of the other side of the main body 100. The reinforcing bar 430 may be detachably fastened to the main body 100 through bolts. Two terminals of the strap part 300 may be respectively connected to the corresponding support parts 200. In addition, one terminal of the sub-strap 410 may be connected to the center portion of the strap part 300 and the other terminal may be connected to the coupling hole 420.

According to this configuration, if the user positions the main body 100 and/or the support part 200 on one side of his or her waist, the strap part 300 may be worn on the shoulder positioned on the same side as the other side of the user's waist. If the sub-strap 410 is connected to substantially the center portion of the strap part 300 and the connecting point is at the apex h1 on the user's shoulder, the strap part 300 and the sub-strap 410 may form a substantially triangular pyramid shape. In addition, both ends of the strap part 300 placed on one shoulder of the user may pull and support both ends of one side of the main body 100, and the sub-strap 410 connected to the center portion of the strap part 300 serves to pull one end of the reinforcing bar 430 toward the user's body. At the same time, the other end of the reinforcing bar 430 may be fixed to the center portion of the other end of the main body 100 so that the main body 100 is prevented from tilting toward the ground. Therefore, even if the user moves the seedling carrying device 10 to the front, back, or side of the user's body as needed during seedling carrying or transplant work, the main body 100 may remain horizontal with respect to the ground by the structure of the strap part 300, the sub-strap 410, and the reinforcing bar 430 connected to the main body 100.

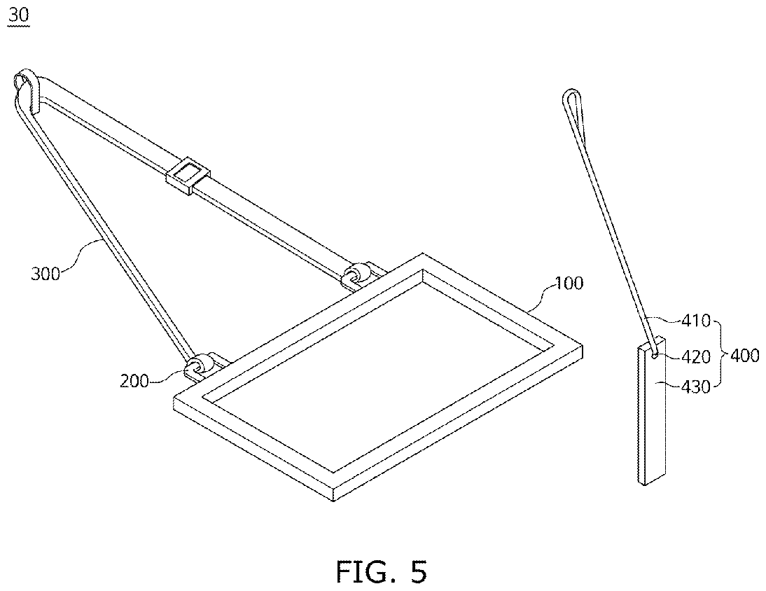

FIG. 5 is an exploded perspective view of the seedling carrying device 30. Referring to FIG. 5, the main body 100 may have a substantially rectangular shape corresponding to the shape of a seed tray (not shown). In addition, the main body 100 may be formed as a square frame having an inner space or hole smaller than at least the edge of the seed tray to receive the lower protruding portion of the seed tray to be seated therein. If the frame of the main body 100 is configured in such a form that a center portion is open, it is possible to mount seed trays having various depths when mounting a seed tray (not shown) in the main body 100.

Since the main body 100 positioned on one side of the user's waist may apply pressure to a corresponding part of the user's body, the main body 100 may be made of a light material. In addition, attaching a cushion pad to the outer surface of the main body 100 that comes in contact with the waist may prevent an injury caused by the outer surface of the main body 100 pressing or rubbing against the wearer's waist when the user works wearing the seedling carrying device 10. While the main body 100 is illustrated and described herein as the square frame, aspects are not limited thereto, and it may have other shapes such as a circular shape or a polygonal shape.

While the frame of the main body 100 is shown in such a form that a center portion is open in FIG. 5, aspects are not limited thereto, and a seating part (e.g., a seating part with a bottom portion made of a rigid material) may be provided in the center portion the frame.

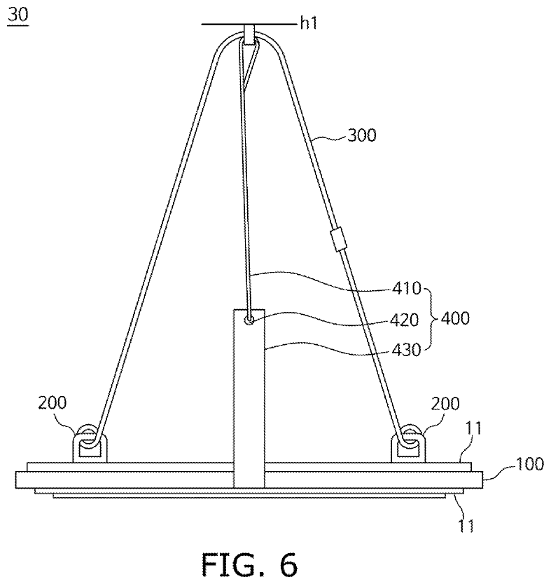

FIG. 6 is a front view showing an example of using the seedling carrying device 30. As shown, if the seed tray seated in the main body 100 has a relatively large depth, the lower end of the seed tray may pass through the lower end of the main body 100. The support parts 200 may be provided on both sides of one side of the main body 100 and connected to both terminals of the strap part 300. At least one reinforcing part 400 may be provided at the center of the other side of the main body 100, and one terminal of the sub-strap 410 may be connected the coupling hole 420 positioned at the upper end of the reinforcing part 400. The other terminal of the sub-strap 410, which is connected to the center portion of the strap part 300, may be placed on the user's shoulder. In this case, the center portion of the strap part 300 to which the sub-strap 410 is connected may be positioned at the apex h1 on one shoulder of the user.

As illustrated, if the seedling carrying device 30 is placed on the user's shoulder, the strap part 300 and the sub-strap 410 may be arranged in a substantially triangular pyramid shape. Since the strap part 300, the sub-strap 410, and the reinforcing bar 430 are placed on the user's shoulder in a substantially triangular pyramid shape as described above, the bottom portion of the main body 100 may remain horizontal with respect to the ground. While the lower end of the main body 100 is shown to have a pass-through structure, aspects are not limited thereto, and a plate-shaped seating part or a mesh-shaped seating part (not shown) made of a flexible material may be provided at a lower end of the main body 100.

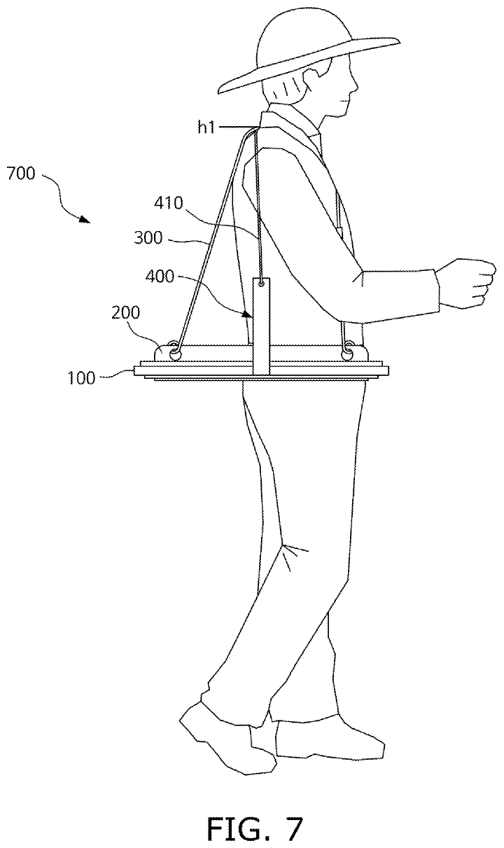

FIG. 7 is an exemplary view showing a state 700 in which the seedling carrying device is placed on the user's shoulder. FIG. 7 shows a user wearing the seedling carrying device placed on the shoulder, in which the main body 100 and/or the support part 200 are in contact with one side of the user's waist and the strap part 300 is placed on the shoulder on the same side as the other side of the waist.

In the illustrated example of using the seedling carrying device, the upper end of the reinforcing part 400 may face the shoulder on one side of the user's waist, and the sub-strap 410 may be connected to the apex h1 which is the center portion of the strap part 300 placed on the shoulder on the same side as the other side of the user's waist. In addition, the sub-strap 410 may be placed on the user's back or the chest. Since the apex h1 of the strap part 300 is placed on the user's shoulder as described above, the strap part 300 and the sub-strap 410 are pulled in a triangular pyramid shape by the weight of the main body 100 and the seed tray (not shown), and the main body 100 may remain horizontal with respect to the ground. In addition, by placing the sub-strap 410 on the user's back or chest, the weight of the main body 100 and the seed tray seated on the main body 100 may be distributed from the strap part 300 placed on the user's shoulder to the sub-strap 410 placed on the back or chest. Therefore, the user may concentrate on work comfortably, with less fatigue from the weight of the device when wearing the seedling carrying device.

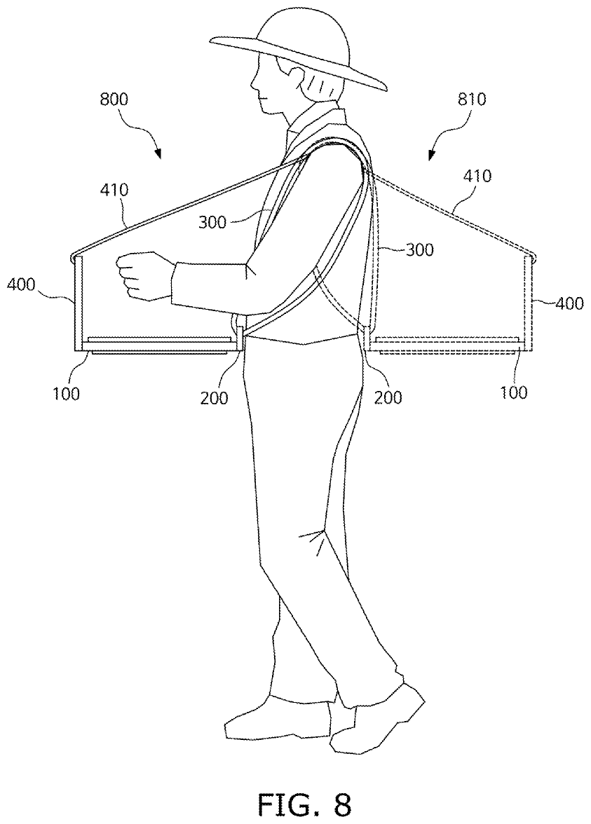

FIG. 8 shows an example in which the user wearing the seedling carrying device placed on his shoulder rotates the main body 100 to a front 800 or back 810. As illustrated, the seedling carrying device may be used while the strap part 300 is placed on one shoulder of the user and the main body 100 is in contact with the waist on the same side as the other shoulder. In this case, when the user moves the main body 100 to the front 800 or to the rear 810 of his body while the strap part 300 is placed on the user's shoulder, the reinforcing bar 430 connected to the sub-strap 410 may be pulled toward the apex h1 on the shoulder. As a result, the sub-strap 410 restricts the tilt of the main body 100 in the moving direction of the main body 100 relative to the longitudinal direction of the reinforcing bar 430 so that the main body 100 may remain horizontal with respect to the ground.

If the main body 100 is moved to the front 810 of the user, a portion of the strap part 300 and the sub-strap 410 may touch or be placed on the user's chest. As a result, the weight of the main body 100 and the seed tray (not shown) seated in the main body 100 may be distributed to the shoulder on which the strap part 300 is placed and the user's chest on which the sub-strap 410 is placed. If the main body 100 is moved to the rear 710, a portion of the strap part 300 and the sub-strap 410 may touch or be placed on the user's back. As a result, the weight of the main body 100 and the seed tray seated in the main body 100 may be distributed to the wearer's shoulder and back.

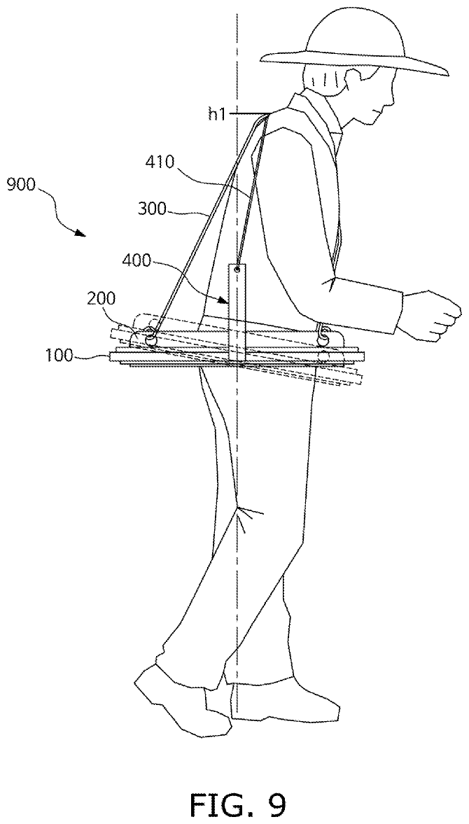

FIG. 9 shows an example 900 in which the user wearing the seedling carrying device placed on the user's shoulder bends at the waist to perform work. If the user bends at the waist during seedling transplant work, the sub-strap 410 may turns about the apex h1 at which the strap part 300 of the seedling carrying device is placed on the shoulder. In addition, gravity acts as much as the weight applied to the main body 100 so that the reinforcing part 400, having one terminal connected to the sub-strap 410, may pull the sub-strap 410 in the vertical direction. The sub-strap 410 pulls the reinforcing part 400 by the action and reaction, while the reinforcing part 400 pulls the sub-strap 410, and with this force of pulling each other, the sub-strap 410 can restrict the turning of the reinforcing part 400. Therefore, even if the reinforcing part 400 tilts in the direction in which the user's waist is turning, the sub-strap 410 pulls the reinforcing part 400 in a vertical direction with respect to the ground so that the reinforcing part 400 may be positioned vertically with respect to the ground. That is, the main body 100 may temporarily turn according to the direction the user is turning and then be positioned in a horizontal state with respect to the ground.

The user may take out a seedling from a seed tray (not shown) seated in the seedling carrying device and insert the seedling into a seedling transplanter having a front end dug into the ground. The user may naturally bend at the waist to transplant the seedlings, but with the strap part 300 being placed at the apex h1 on the shoulder and the sub-strap 410 being brought into contact with the user's back, the main body 100 may remain horizontal with respect to the ground. In addition, as shown in FIG. 8, even if the main body 100 is positioned at the rear 810, the sub-strap 410 may be placed on the user's chest so that the main body 100 may remain horizontal with respect to the ground.

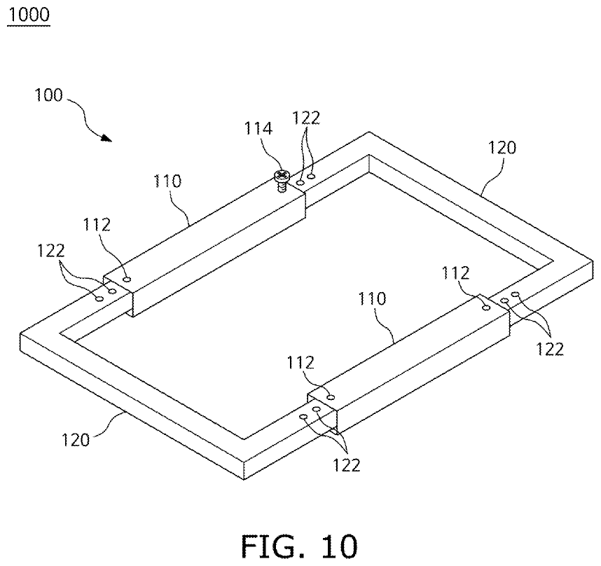

FIG. 10 is a perspective view showing an example of a configuration in which the size of the main body 100 used in the seedling carrying device is variably adjusted in the horizontal direction. As shown, the main body 100 may include a fixed body 110 and a movable body 120. The main body 100 is configured such that the size of the main body 100 is adjusted in the longitudinal direction in response to an operation of inserting and retracting the terminal portions of the movable body 120 through openings of both terminals of the frame of the fixed body 110.

Specifically, the fixed body 110 may at least include first fastening holes 112 respectively formed on one and the other sides. The movable body 120 may be formed so as to be inserted through the frame of the fixed body 110. In addition, the movable body 120 may include a second fastening hole 122 including at least one hole at a position corresponding to the first fastening hole 112 when the movable body 120 is inserted into the frame of the fixed body 110. When the movable body 120 is inserted into the frame of the fixed body 110 such that the first fastening hole 112 and the second fastening hole 122 are arranged at a position so as to correspond to each other, the first fastening hole 112 and the second fastening hole 122 are fastened by a fastening screw 114 so that the fixed body 110 and the movable body 120 may be fixedly connected.

When the movable body 120 is inserted into the fixed body 110, the seed tray may be arranged in the space inside the frame of the main body 110. In this state, while moving the movable body 120 inside the frame of the fixed body 110 to make the width of the frame or the length of one side of the fixed body 110 correspond to the width of the seed tray or the length of one side, it is possible to adjust the movable body 120 so that the holes of the first fastening hole 112 and the second fastening hole 122 correspond to each other. The fixed body 110 and the movable body 120 may be fixed to each other by passing the fastening screw 114 through the first fastening hole 112 and the second fastening hole 122. As a method of fixing the fixed body 110 and the movable body 120 above, it is described above that the fastening screw 114 is fastened through the first fastening hole 112 and the second fastening hole 122, but aspects are not limited thereto. For example, the fixed body 110 and the movable body 120 may be coupled to each other using a locking method such as clamping, peg, hook, or magnetic locking device. In addition, FIG. 10 shows only one fastening screw 114, but aspects are not limited thereto. Accordingly, a plurality of fastening screws 114 may be used, and nuts (not shown) and washers (not shown) for fixing the fastening screws 114 may be additionally used.

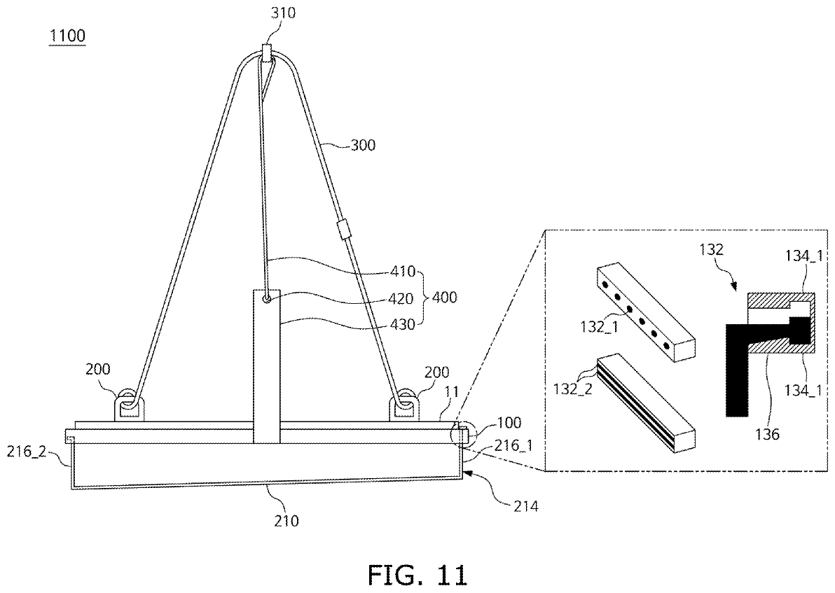

FIG. 11 is a front view showing an example 1100 of a configuration in which the size of the seating part 210 used in the seedling carrying device is variably adjusted in the vertical direction. As shown, the seedling carrying device may include the main body 100, the support part 200, the seating part 210, the strap part 300, and the reinforcing part 400. Insertion recesses 132_1 and 132_2 may be formed in the frame of the main body 100. In addition, the seating part 210 may be arranged in the open center portion of the frame of the main body 110.

Specifically, the seating part 210 may include seating part shafts 216_1 and 216_2, in which the seating part shafts 216_1 and 216_2 may be mounted in the insertion recesses 132_1 and 132_2 positioned in the frame of the main body 100. The insertion recesses 132_1 and 132_2 may be circular holes 132_1 or rectangular holes 132_2 formed on an inner or outer surface of the frame of the main body 100. The seating part shafts 216_1 and 216_2 having the configuration described above may be inserted into the insertion recesses 132_1 and 132_2, and may have hook-shaped fastening portions at terminals thereof. The size of the holes of the insertion recesses 132_1 and 132_2 may be set such that the fastening portions of the seating part shafts 216_1 and 216_2 may be inserted therein. In addition, an inner upper portion 134_1 and an inner lower end 134_2 of the insertion recesses 132_1 and 132_2 may respectively include a stepped concave portion into which the fastening portion of the seating part shafts 216_1 and 216_2 may be inserted, and the inner lower end 134_2 may be inclined (136) toward the entrance of the insertion recesses 132_1 and 132_2. The insertion recesses 132_1 and 132_2 are shown in a circular or rectangular shape, but not limited thereto and may be formed in various shapes.

Meanwhile, while wearing the seedling carrying device placed on the shoulder, the user may insert the seating part 210 into the inner space of the main body 100 to place the seed tray in the inner space of the frame of the main body 100. In this case, the fastening portion of a seating part shaft 216 may be inserted into the insertion recesses 132_1 and 132 2, and the fastening portion of the seating part shaft 216 may be fixedly placed in the concave portion of the inner lower end 134_2 of the insertion recesses 132_1 and 132_2. The inclination 136 of the inner lower end 134_2 of the insertion recesses 132_1 and 132_2 may allow the fastening portion of the seating part shaft 216 to be smoothly placed in the insertion recesses 132_1 and 132_2 at the time of insertion, and the seating part shaft 216 fastened to the concave portion of the inner lower end 134_2 formed over the inclination may not easily fall out.

In another example, if the seedling carrying device is seated on the ground while the seating part 210 is in the state of being seated in the main body 100 of the seedling carrying device, the upper portion of the fastening portion of the seating part shafts 216 inserted into the insertion recesses 132_1 and 132_2 may be fixedly fastened to the concave portion of the inner upper portion 134_1 of the insertion recesses 132_1 and 132_2. As a result, the seating part 210 may remain mounted in the main body 100 even if the seedling carrying device is seated on the ground.

In still another example, the seating part shafts 216_1 and 216_2 may be selectively fastened to one of the two or more insertion recesses 132_2 formed on the inner surface of the frame of the main body 100 so that the depth of the seating part 210 may be adjusted. For example, if the seating part 210 is set shallow, the seating part shaft 216_1 may be fastened to the upper insertion recess 132_2 formed in the inner surface of the frame of the main body 100. In contrast, if the seating part 210 is set deep, the seating part shaft 216_2 may be fastened to the lower insertion recess 132_2 formed in the inner surface of the frame of the main body 100.

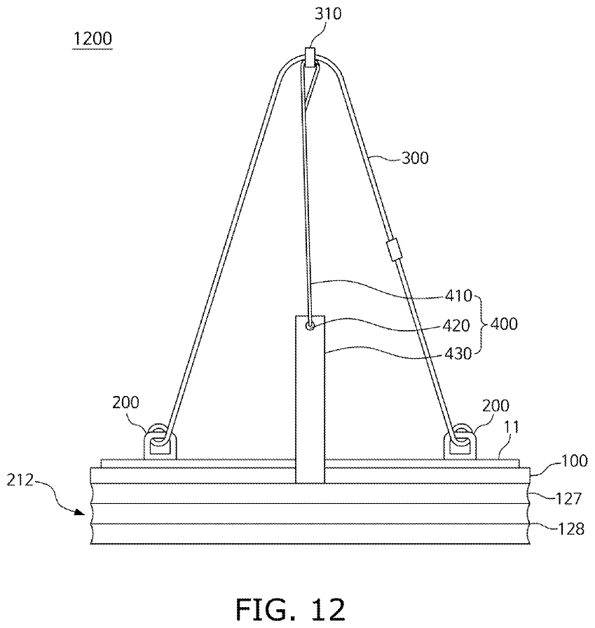

FIG. 12 is a front view showing another example 1200 of a configuration in which the size of a seating part used in the seedling carrying device is variably adjusted in the vertical direction. The seedling carrying device may include the main body 100, the support part 200, a foldable seating part 212, the strap part 300, and the reinforcing part 400. The foldable seating part 212 may be provided on at least one of bottom and side of the main body 100, and adjustable in the depth thereof according to the size of the seed tray seated in the seating part 212.

As shown, the foldable seating part 212 may be made of a material that may contract or expand and may include a concave portion 127 and a convex portion 128 connected to each other to allow contraction or expansion of the surface thereof. In this configuration, when reducing the height of the seating part 212 of the seedling carrying device, the convex portions 128 positioned above and below the concave portion 127 may be adjusted to be close to each other so that the height of the concave portion 127 is reduced. Conversely, when increasing the height of the seating part 212 of the seedling carrying device, the convex portions 128 positioned above and below the concave portion 127 may be adjusted to be spaced apart from each other so that the height of the concave portion 127 is increased.

As described above, certain examples of the present invention are described in the detailed description of the present invention, but these illustrate the preferred examples of the present invention and do not limit the present invention. In addition, it is of course possible for those skilled in the art to which the present invention pertains to make various modifications within the scope without departing from the technical spirit of the present invention.

Therefore, the scope of the present invention is not to be limited to the examples described above, but implemented in various forms within the scope of the appended claims. Further, it is to be noted that any modification by those skilled in the art to which the present invention pertains without departing from the gist of the present invention as claimed in the scope of claims is deemed to be within the scope of the claims of the present invention.

1. A seedling carrying device comprising:
a main body configured to support a seed tray;
support parts connected to both sides of one side of the main body;
a strap part including two terminals connected to the support parts and configured to be placed on a user's shoulder; and
a reinforcing part connected to a center portion of the other side of the main body and connected to a center portion of the strap part.

2. The seedling carrying device according to claim 1, comprising:
a seating part which is mounted on one surface of the main body and on which a lower surface of the seed tray is seated.

3. The seedling carrying device according to claim 1, wherein the strap part is configured such that, if the main body is positioned on one side of a user's waist, the strap part is placed on a shoulder in a same direction as the other side of the user's waist.

4. The seedling carrying device according to claim 1, wherein the reinforcing part includes:
a reinforcing bar configured to protrude at a predetermined angle with respect to one side of the main body; and
a sub-strap including two terminals connected to one terminal of the reinforcing bar and to the center portion of the strap part.

5. The seedling carrying device according to claim 4, wherein the reinforcing bar includes a coupling hole formed at an upper end, and
one terminal of the sub-strap is connected to the coupling hole, and the other terminal is connected to the strap part.

6. The seedling carrying device according to claim 4, wherein, when the strap part is placed on the user's shoulder, the sub-strap is connected to the center portion of the strap part to form a triangular pyramid having the shoulder as an apex.

7. The seedling carrying device according to claim 4, wherein the reinforcing part is configured such that, if the user wearing the strap part placed on the user's shoulder turns waist in one direction, the user's shoulder turns in one direction about the apex at which the strap part is placed as an axis and the sub-strap is pulled in the axial direction, so that the sub-strap restricts tilt of the main body in the direction in which the waist is turning relative to a longitudinal direction of the reinforcing bar, thereby maintaining the main body in a horizontal state with respect to the ground.

8. The seedling carrying device according to claim 4, wherein the reinforcing part is configured such that, if the user wearing the strap part on the user's shoulder moves the main body to a front or rear with respect to the user's body, the sub-strap is pulled toward the apex where the strap part is placed, so that the sub-strap restricts tilt of the main body in the direction in which the main body is moving relative to the longitudinal direction of the reinforcing bar, thereby maintaining the main body horizontally with respect to the ground.

9. The seedling carrying device according to claim 1, wherein the main body is configured to adjust a size of the main body in a longitudinal direction of the main body.

10. The seedling carrying device according to claim 9, wherein the main body includes:
a fixed body including a frame including first fastening holes formed on both sides; and
a movable body to be inserted into the frame of the fixed body and including second fastening holes corresponding to the first fastening holes.

11. The seedling carrying device according to claim 1, wherein the main body is configured to adjust the size of the main body in a depth direction of the main body.

12. The seedling carrying device according to claim 11, wherein the main body includes:
at least one insertion recess formed in an inner surface of the frame of the main body; and
a seating part on which a lower surface of the seed tray is seated, and which includes a seating part shaft to be inserted into and fastened to the insertion recess.

13. The seedling carrying device according to claim 1, further comprising a cushion part formed on a portion of one side of the main body and configured to be in contact with the user's waist.
